(19) United States
(12) Patent Application Publication
(10) Pub. No.: US 2007/0052786 A1
(43) Pub. Date: Mar. 8, 2007

(54) Active energy ray curable inkjet apparatus

(75) Inventor: Yusuke Nakazawa, Shizuoka (JP)

Correspondence Address: SUGHRUE-265550, 2100 PENNSYLVANIA AVE. NW, WASHINGTON, DC, 20037-3213, US

(73) Assignee: FUJI PHOTO FILM CO., LTD.

(21) Appl. No.: 11/514,238

(22) Filed: Sep. 1, 2006

(30) Foreign Application Priority Data
Sep. 1, 2005 (JP) P.2005-253524

(51) Int. Cl. B41J 2/01

(52) U.S. Cl. 347/102

(57) ABSTRACT

An active energy ray curable inkjet apparatus 100 comprising: an inkjet head 45 adapted to discharge ink, which is curable by active energy rays, to a recording medium S; and a displacement unit 43 adapted to cause the recording medium S and the inkjet head 45 to perform relative displacement, wherein the active energy ray curable inkjet apparatus 100 further comprises: an ink collection sheet supply unit 67 adapted to perform face-to-face supply of a spitting ink collection sheet to nozzles of the inkjet head 45.

### BACKGROUND OF THE INVENTION

1. Field of the Invention

The present invention relates to an active energy ray curable inkjet apparatus using ink adapted to be cured by active energy rays, such as electron beams and ultraviolet rays, and, more particularly, to an improvement of the technique of collecting ink the spitting of which has been performed.

2. Description of the Related Art

A related inkjet recording apparatus is configured to have a plurality of piezoelectric devices, a plurality of nozzle holes respectively corresponding to the plurality of piezoelectric elements, and a substrate adapted to discharge ink droplets from the nozzle holes in response to vibrations of the piezoelectric elements. The substrate is constituted by a nozzle plate in which the plurality of nozzle holes are bored, and a flow path forming member adapted to form a flow path communicating with each of the nozzle holes. When a voltage is applied to each of the piezoelectric elements, each of the piezoelectric elements displaces. This displacement of each of the piezoelectric elements changes the internal volume of a corresponding one of the flow paths. Then, the internal pressure of the flow path increases, so that ink droplets are discharged from the nozzle hole corresponding to the flow path.

Meanwhile, in recent years, an active energy ray inkjet apparatus has been proposed, which discharges ink adapted to be cured by active energy rays, such as ultraviolet rays or electron beams, using an inkjet head onto a recording medium and then cures the ink by the irradiation of the active energy rays to thereby form an image. This active energy ray inkjet apparatus has features that this inkjet apparatus is environmentally friendly, that images can be recorded on various recording media and that because the ink is hard to blur, highly fine images can be obtained. Due to these advantages, this active energy ray inkjet apparatus is expected to be highly available as an industrial inkjet apparatus enabled to record a wide drawing range, which performs, for example, wide-format recording, textile printing, large-format poster printing, and wallpaper printing.

On the other hand, the inkjet apparatus has a large number of nozzles provided in the inkjet head. When a discharge failure of the nozzle occurs, the discharge failure is recognized as an image defect. The discharge failures appear prominently in the nozzles that halt the discharge of the ink partially. This is because the ink is not agitated in the idling nozzle, so that the evaporation of ink solvent and the separation of gradients of the ink make it difficult to discharge the ink. To prevent an occurrence of this phenomenon, an idle discharge operation called spitting is frequently performed when the head is not present on a recording area.

### SUMMARY OF THE INVENTION

However, in a related single-path-system type inkjet apparatus configured to perform recording by using a full-line head and by causing a recording medium to pass through a place just below the head only once, the head is always present above a recording area. Thus, spitting cannot be performed by moving the head to a spitting maintenance portion. Consequently, this related inkjet apparatus has no effective means for preventing an occurrence of clogging of the nozzle.

Also, in a related inkjet apparatus having a multichannel type head adapted to move in a direction perpendicular to a recording medium conveying direction, the head should be moved to a spitting maintenance portion placed outside a recording area. Thus, this related inkjet apparatus has a drawback in that in a case where the head is moved while an image is formed, an image forming time is long, and that the size of the apparatus is large because the spitting maintenance portion is provided outside the recording area.

The invention is accomplished in view of the aforementioned circumstances. An object of the invention is to provide an active energy ray curable inkjet apparatus enabled to easily perform spitting especially even in a case where a full-line head is provided therein, and also enabled to suppress nozzle clogging thereby speeding up image formation and enhancing image quality.

The aforementioned object of the invention is achieved by the following apparatuses.

(1) An active energy ray curable inkjet apparatus comprising:

an inkjet head adapted to discharge ink, which is curable by active energy rays, to a recording medium; and

a displacement unit adapted to cause the recording medium and the inkjet head to perform relative displacement,

wherein the active energy ray curable inkjet apparatus further comprises:

an ink collection sheet supply unit adapted to perform face-to-face supply of a spitting ink collection sheet to nozzles of the inkjet head.

According to this active energy ray curable inkjet apparatus, even in a case where the inkjet apparatus has a full line head in which the face-to-face supply of the spitting ink collection sheet to the nozzles of the inkjet head is performed and which the head is always present above the recording area, the spitting is enabled. Also, in a case where the head of the inkjet apparatus is of the multichannel type adapted to move in a direction perpendicular to the recording medium conveying direction, the spitting is enabled without moving the head to the maintenance portion placed outside the recording area. Further, there is no necessity for providing the spitting maintenance portion outside the recording area.

(2) The active energy ray curable inkjet apparatus as described in (1) above,

wherein the ink collection sheet supply unit is provided at the inkjet head.

According to this active energy ray curable inkjet apparatus, the ink collection sheet supply unit is integral with the inkjet head. This eliminates the need for aligning the ink collection sheet supply unit with the inkjet head. Consequently, the supply of the ink collection sheet to the nozzles can quickly be performed with optional timing.

(3) The active energy ray curable inkjet apparatus as described in (1) above, which further comprises:

a band-like ink collection sheet intervened between the recording medium and the inkjet head; and

a pair of sheet winding rollers adapted to take up and draw out both ends in a longitudinal direction of the band-like ink collection sheet,

wherein a drawing hole, through which nozzles juxtaposed in the inkjet head are exposed, is formed in the band-like ink collection sheet.

According to this active energy ray curable inkjet apparatus, normally, when the drawing hole is made to coincide with the nozzles, ink discharged from the nozzles can be landed on the recording medium. When the nozzles are cleaned, the sheet winding rollers are turned to cause the drawing hole to deviate from the nozzles, so that the ink collection sheet is made to coincide with the nozzles and that ink discharged from the nozzles can be landed on the ink collection sheet. With this configuration, the ink collection sheet supply unit can be constituted by a relatively simple structure including only a mechanism adapted to take up the ink collection sheet in which the drawing hole is bored.

(4) The active energy ray curable inkjet apparatus as described in (1) above, which further comprises:

a band-like ink collection sheet intervened between the recording medium and the inkjet head; and

a pair of sheet winding rollers adapted to take up and draw out both ends in a longitudinal direction of the band-like ink collection sheet,

wherein the pair of sheet winding rollers is movable along a recording medium conveying direction by at least a distance by which the ink collection sheet deviates from the nozzles of the inkjet head.

According to this active energy ray curable inkjet apparatus, normally, the pair of sheet winding rollers is moved along the recording medium conveying direction, so that the ink collection sheet is disposed to deviate from the nozzles, and that ink discharged from the nozzles can be landed on the recording medium. Also, when the nozzles are cleaned, the pair of sheet winding rollers is moved and disposed along the recording medium conveying direction, so that ink discharged from the nozzles can be landed on the ink collection sheet. With this configuration, when the sheet winding rollers are moved, so that the ink collection sheet can retreat. This eliminates the necessity for using the ink collection sheet in which the drawing hole is bored.

(5) The active energy ray curable inkjet apparatus as described in (3) or (4) above, which further comprises:

a cleaning unit adapted to clean ink landed onto the band-like ink collection sheet.

According to this active energy ray curable inkjet apparatus, ink landed on the ink collection sheet by spitting is removed by the cleaning unit. This prevents ink-dripping from being caused by accumulation of ink landed on the ink collection sheet.

(6) The active energy ray curable inkjet apparatus as described in any one of (3) to (5) above,

wherein a thickness of a downstream edge in a recording medium conveying direction, which extends in a width direction perpendicular to a longitudinal direction of the band-like ink collection sheet, is thinner than a thickness of an upstream edge in the recording medium conveying direction of the band-like ink collection sheet.

According to this active energy ray curable inkjet apparatus, the ink collection sheet is formed so that the thickness of a downstream edge in a recording medium conveying direction, which extends in a width direction perpendicular to the longitudinal direction of the ink collection sheet, is thinner than the thickness of an upstream edge in the recording medium conveying direction thereof. Thus, the distance between the recording medium and the ink collection sheet is large at the downstream side in the width direction of the ink collection sheet. This makes it difficult to bring the ink collection sheet into contact with the ink landed on the recording medium.

### BRIEF DESCRIPTION OF THE DRAWINGS

FIG. 1 is a schematic view illustrating a configuration of an active energy ray curable inkjet recording apparatus according to an exemplary embodiment of the invention;

FIG. 2 is a perspective view illustrating ink path connection centered on ink tank units;

FIG. 3 is a perspective view illustrating an image recording portion;

FIG. 4 is an enlarged perspective view illustrating a primary part of the image recording portion;

FIG. 5 is a perspective view illustrating an example of an ink collection sheet supply unit;

FIG. 6 is a cross-sectional view taken on line A-A shown in FIG. 5;

FIGS. 7A to 7C are explanatory views respectively illustrating phases of an operation of an ink collection sheet supply unit of an active energy ray curable inkjet recording apparatus according to a second exemplary embodiment;

FIG. 8A is an explanatory plan view illustrating the ink collection sheet shown in FIGS. 7A to 7C. FIG. 8B is an explanatory cross-sectional view of the ink collection sheet, which is taken on line B-B shown in FIG. 8A;

FIG. 9 is an enlarged perspective view illustrating an ink collection sheet supply unit of an active energy ray curable inkjet recording apparatus according to a third exemplary embodiment;

FIG. 10 is a schematic view illustrating another configuration of an active energy ray curable inkjet recording apparatus;

FIG. 11 is a schematic view illustrating still another configuration of an active energy ray curable inkjet recording apparatus; and

FIG. 12 is a schematic view illustrating a configuration of an active energy ray curable inkjet recording apparatus according to another exemplary embodiment of the invention.

### DETAILED DESCRIPTION OF THE INVENTION

Hereinafter, preferred embodiments of an active energy ray curable inkjet apparatus are described with reference to the accompanying drawings.

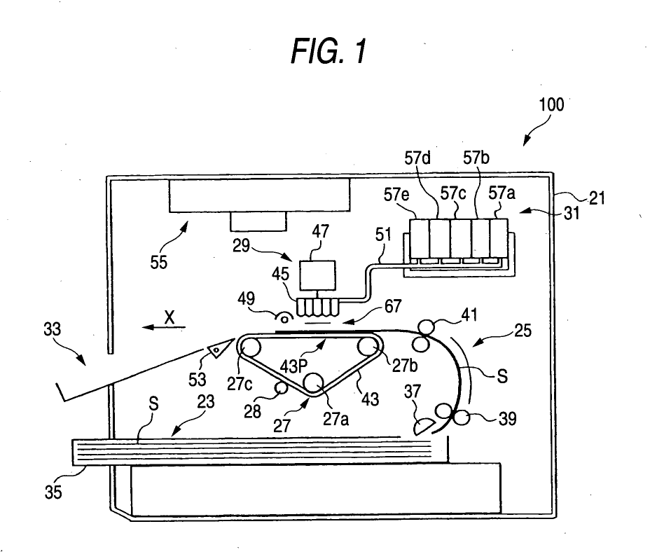

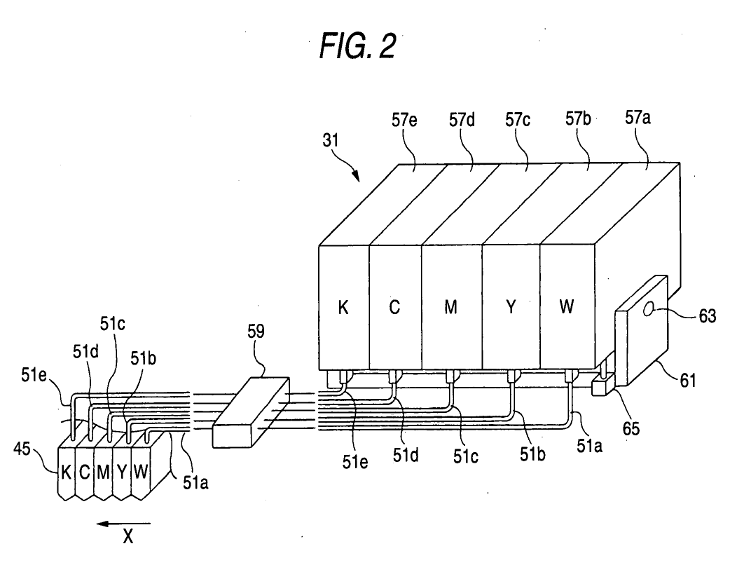

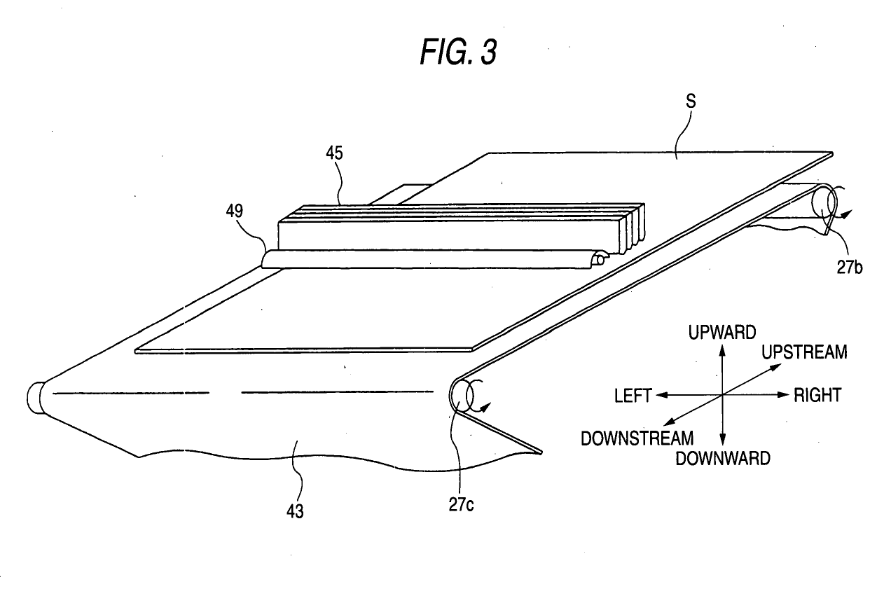

FIG. 1 is a schematic view illustrating a configuration of an active energy ray curable inkjet recording apparatus according to an embodiment of the invention. FIG. 2 is a perspective view illustrating ink path connection centered on ink tank units. FIG. 3 is a perspective view illustrating an image recording portion.

As shown in FIG. 1, in a casing 21 of an active energy ray curable inkjet recording apparatus, a recording medium accommodating portion 23 adapted to accommodate a plurality of sheets of sheet-like recording media S of the same size by stacking the recording media S, a conveying portion 25 adapted to take the recording media S out of this accommodating portion 23, a scanning conveyance portion 27 adapted to scan the recording media S conveyed by the conveying portion 25 while the recording media S are held within a recording portion range, an image recording portion 29 adapted to perform inkjet image recording, active energy ray irradiation-fixation (ultraviolet irradiation-fixation in this embodiment) on the recording media S held, transported, and scanned by the scanning conveyance portion 27, a cartridge mounting portion 31 adapted to store ink to be supplied to the image recording portion 29, and a tray 33 to which the recording media S having been used for recording are sent, are provided.

In the recording medium accommodating portion 23, an accommodating cassette 35 adapted to accommodate the recording medium S is detachably disposed in a lower part of the casing 21 of the active energy ray curable inkjet recording apparatus 100. A recording medium S of a different size can be supplied by being replaced with the recording medium S originally accommodated therein. The recording medium accommodating portion 23 can be configured so that a plurality of cassettes are mounted therein. The conveying portion 25 has a feed roller 37 adapted to abut against an end portion in an insertion direction of the recording medium S accommodated in the accommodating cassette 35 set in the casing 21. Also, the conveying portion 25 has a pair of conveying rollers 39 and 41 used for conveying the recording media S, which are drawn out by using the feed roller 37, to the scanning conveyance portion 27.

The scanning conveyance portion 27 has a conveying belt 43, which serves as a displacement unit and which is stretched and is driven by three belt rollers 27a, 27b, and 27c. A tension roller is pushed against the conveying belt 43 that is stretched and is driven by the belt rollers 27a, 27b, and 27c. A tension roller 28 gives predetermined tension to the conveying belt. The conveying belt 43 is driven in an X-direction oriented from an upstream belt roller 27b to a downstream belt roller 27c. The recording medium S is put on the conveying belt 43 and is conveyed between the upstream belt roller 27b and the downstream belt roller 27c. That is, the conveying belt 43 causes the recording medium S and a head unit 45 (to be described later) to perform relative displacement.

The image recording portion 29 has the head unit 45 adapted so that the cartridge mounting portion 31 is connected thereto for supplying ink thereto, and that an end part of an ink injecting portion of the head unit 45 serving as an inkjet head is directed at an image recording position 43P toward the conveying belt 43. The head unit 45 discharges ink, which is curable by active energy rays, toward the recording medium S. A head driver 47 is connected to the head unit 45 and controls an amount of discharged ink of each color. Also, the cartridge mounting portion 31 is connected to the head unit 45 and the head driver 47 so as to supply ink thereto. Ink supply paths 51 are connected from the cartridge mounting portion 31 to the head unit 45.

An ultraviolet irradiating portion 49 serving as an active energy ray precedent-irradiation unit is disposed just behind the image recording position downstream from the head unit 45. The ultraviolet irradiating portion 49 gives strong active energy sufficient to the extent that ink is landed on the recording medium S and is immediately subsequently cured. That is, the ultraviolet irradiating portion 49 is disposed at the downstream side in the recording medium conveying direction and irradiates active energy rays onto the recording medium S to thereby cure color ink.

A peeling claw 53 is disposed downstream from a position (the position of the downstream belt roller 27c in the present embodiment) at which the recording medium S is detached from the conveying belt 43. A tip end of the peeling claw 53 touches the conveying belt 43 in the vicinity of the downstream belt roller 27c to thereby induce the peeling of the recording medium S from the conveying belt 43. The tray 33 accommodates the recording medium S peeled from the conveying belt 43.

As described above, the ultraviolet irradiating portion 49 uses strong light for curing ink. Thus, an exhaust cooling portion 55 is disposed at an upper part in the casing 21 to suppress the rise of temperature in the casing 21.

Another configuration of the aforementioned recording medium accommodating portion 23 may be implemented by a cassette adapted to supply a recording medium wound around a roll. In this case, a cutter adapted to cut the recording medium to a desired length, instead of the feed roller 37 of the conveying portion 25.

As shown in FIG. 2, a plurality of cartridges 57a, 57b, 57c, 57d, and 57e are mounted in the cartridge mounting portion 31. The cartridges 57a, 57b, 57c, 57d, and 57e store W (white) ink, M (magenta) ink, C (cyan) ink, and K (black) ink, respectively. Each of the cartridges 57a, 57b, 57c, 57d, and 57e is connected to the head unit 45 through a corresponding one of the ink supply paths 51 formed independent of one another, and is demountably mounted in the cartridge mounting portion 31.

The ink supply paths 51 are divided into independent systems of ink supply paths 51a, 51b, 51c, 51d, and 51e. An ink supply path vibration portion 59 is provided at a middle point in a length direction of each of the ink supply paths 51. The configuration of the ink supply path vibration portion 59 is not shown. An example of the ink supply path vibration portion 59 has ultrasonic transducers each of which touches the exterior of a corresponding one of the ink supply paths 51a, 51b, 51c, 51d, and 51e. This ink supply path vibration portion performs an operation of agitating ink contained in each of the ink supply paths by driving a corresponding one of the ultrasonic transducers. Another example of the ink supply path vibration portion 59 is provided with eccentric rotation type oscillation units placed to be in contact with the ink supply paths 51a, 51b, 51c, 51d, and 51e. This ink supply path vibration portion suppresses the precipitation of ink contained in the ink supply paths by shaking the ink supply paths.

Incidentally, a metal material may be employed as the material of the ink supply paths 51a, 51b, 51c, 51d, and 51e, so that each of the ink supply paths can have a deformation-resistant structure constituted by a metal pipe. However, from standpoints of the ease of shaking ink contained in the ink supply paths and the durability of the joint portions between the ink supply paths 51a, 51b, 51c, 51d, and 51e and the ink cartridges 57a, 57b, 57c, 57d, and 57e and the junction part between the head unit 45 and each of the ink supply paths 51a, 51b, 51c, 51d, and 51e, it is preferable that each of the ink supply paths has a flexible structure constituted by a plastic tube.

Next, the vibration portion provided in the cartridge mounting portion 31 is described below. The cartridges 57a, 57b, 57c, 57d, and 57e are supported by a yoke 61 so that the cartridges 57a, 57b, 57c, 57d, and 57e are sandwiched by the yoke 61. The yoke 61 is fixed to the casing 21. The cartridges 57a, 57b, 57c, 57d, and 57e are pivotally supported by a holding shaft 63 of the yoke 61 so that the cartridges 57a, 57b, 57c, 57d, and 57e can swing as one unit. An actuator 65 adapted to connect the setting edge of each of the cartridges to the yoke 61 is provided in the cartridge mounting portion 31. Thus, the vibration portion includes the yoke 61, the holding shaft 63, and the actuator 65.

As shown in FIG. 3, in the present embodiment, the head unit 45 includes a full line type head having an inkjet nozzle array, one side of which extends in the direction of and has a length being equal to the width of the recording medium S. Accordingly, the head unit 45 is fixed to and is supported by the casing 21 (see FIG. 1), using a bracket (not shown).

Although the head unit 45 of the present embodiment includes the full line head in which the inkjet nozzles are arranged in the width direction of the recording medium S, the head unit 45 may employ a scan type head adapted to scan in a direction perpendicular to a direction in which the recording medium S is conveyed. In this case, the ultraviolet irradiating portion is provided in the apparatus to move with the scan type head. Although the inkjet recording position is moved by the conveying belt in the present embodiment, the apparatus may employ another configuration in which the inkjet recording position is moved on a platen while the recording medium is sandwiched by the conveying rollers.

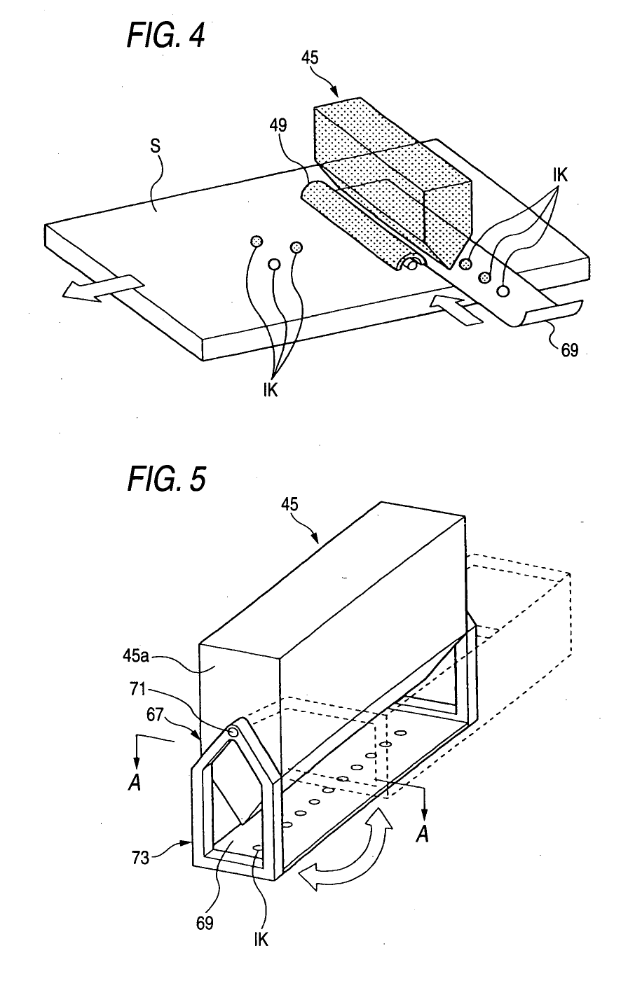

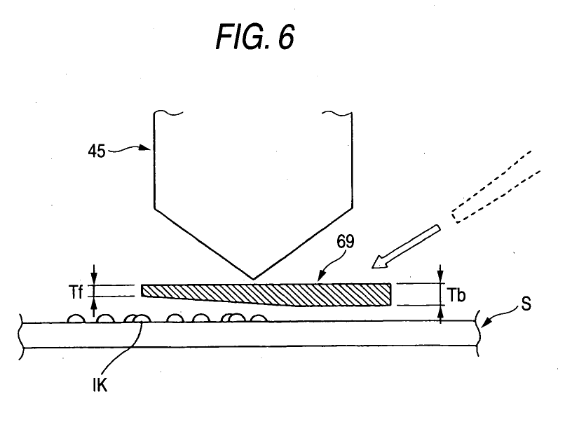

FIG. 4 is an enlarged perspective view illustrating a primary part of the image recording portion. FIG. 5 is a perspective view illustrating an example of the ink collection sheet supply unit. FIG. 6 is a cross-sectional view taken on line A-A shown in FIG. 5.

As shown in FIG. 4, the active energy ray curable inkjet recording apparatus 100 according to the present embodiment has the ink collection sheet supply unit 67 (see FIG. 1) provided in the head unit 45. The ink collection sheet supply unit 67 is enabled to perform the face-to-face supply of the spitting ink collection sheet 69 to the nozzles (not shown) of the head unit 45, as shown in FIG. 4. Ink IK discharged by performing spitting (idle discharge) on the head unit 45 is landed on the ink collection sheet 69. As a result of performing spitting on the head unit 45, ink is agitated. Also, the shortage of ink solvent due to evaporation is compensated. The separation of ingredients of ink is prevented. Consequently, the clogging of idling nozzles can be prevented.

According to this apparatus, the ink collection sheet supply unit 67 is formed integrally with the head unit 45. This eliminates the necessity for aligning the ink collection sheet supply unit 67 with the head unit 45. Consequently, the supply of the ink collection sheet 69 to the nozzles can quickly be performed with optional timing.

The ink collection sheet supply unit 67 can be configured so that a frame-like bracket 73 provided on each of the side surfaces 45a of the head unit 45 to be turnable through a shaft 71, and that a band-like ink collection sheet 69 is held on the bottom surface portion of the bracket 73. The bracket 73 can be disposed by an actuator (an electromagnetic plunger (not shown) or an electric motor (not shown)) or by manually at a position indicated by solid lines and at another position indicated by dashed lines.

Preferably, materials resistant to ink, such as polyimide, PET, and PEN, can be used as the material of the ink collection sheet 69. Even in a case where materials, which are not resistant to ink, are used as the material of the ink collection sheet 69, the ink collection sheet 69 can be employed by being adapted to be replaceable after used several times.

Also, preferably, the ink collection sheet 69 is formed so that the thickness Tf of a downstream edge in a recording medium conveying direction, which extends in a width direction perpendicular to the longitudinal direction of the ink collection sheet, is thinner than the thickness Tb of an upstream edge in the recording medium conveying direction thereof, as shown in FIG. 6. Thus, the distance between the recording medium S and the ink collection sheet 69 is large at the downstream side in the width direction of the ink collection sheet 69. Consequently, it is difficult for the ink collection sheet 69 to touch the ink IK landed on the recording medium S.

In the active energy ray curable inkjet apparatus 100 having such a configuration, the face-to-face supply of the spitting ink collection sheet 69 to the nozzles of the head unit 45 can be performed by turning the bracket 73. Consequently, even in a case of the inkjet apparatus 100 having a full-line type head, in which the head unit 45 is always present above the recording area, the spitting can be performed.

Therefore, the active energy ray curable inkjet apparatus 100 has the ink collection sheet supply unit 67 adapted to perform face-to-face supply of a spitting ink collection sheet 69 to nozzles of the inkjet head 45. Thus, even in a case where the head unit 45 has a full line head in which the head is always present above the recording area, the face-to-face supply of the ink collection sheet 69 to the nozzles can be achieved. Also, the spitting can easily be performed. The clogging of the nozzles can be suppressed. Consequently, the image quality of an image formed by the apparatus can be enhanced.

Next, a second embodiment of the active energy ray curable inkjet apparatus according to the invention is described below.

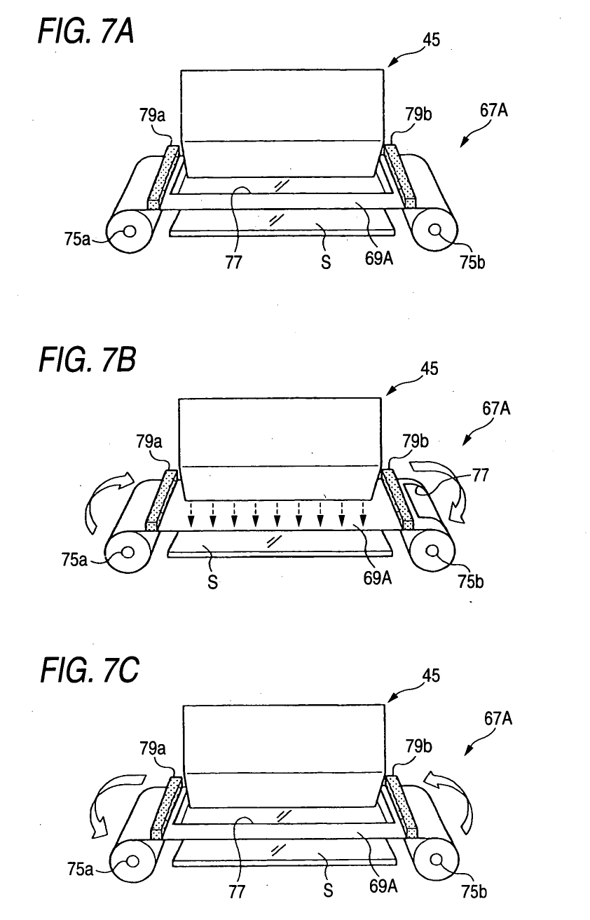

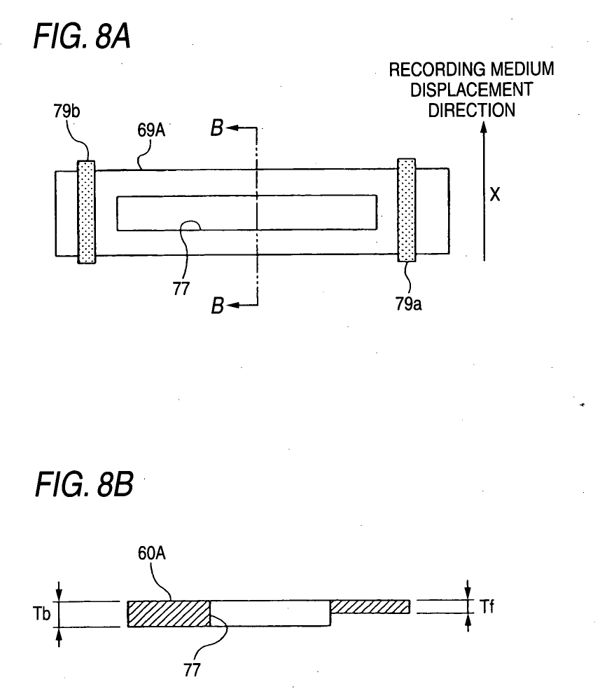

FIGS. 7A to 7C are explanatory views respectively illustrating phases of an operation of an ink collection sheet supply unit of an active energy ray curable inkjet recording apparatus according to a second embodiment. FIG. 8A is an explanatory plan view illustrating the ink collection sheet shown in FIGS. 7A to 7C. FIG. 8B is an explanatory cross-sectional view of the ink collection sheet, which is taken on line B-B shown in FIG. 8A.

As shown in FIG. 7A, the active energy ray curable inkjet recording apparatus according to the present embodiment is configured to include a band-like ink collection sheet 69A intervened between the recording medium S and the inkjet head 45, and a pair of sheet winding rollers 75a and 75b adapted to take up and draw out both ends in a longitudinal direction of the ink collection sheet 69. Additionally, a drawing hole 77, through which nozzles juxtaposed in the head unit 45 are exposed, is formed in the ink collection sheet 69A.

Also, each of cleaning unit 79a and 79b is provided in the vicinity of a corresponding one of the sheet winding rollers 75a and 75b. The cleaning unit 79a and 79b serve to clean the ink IK landed on the ink collection sheet 69A. For example, nonwoven cloths and felt can be used as the materials of the cleaning unit 79a and 79b. The cleaning unit 79a and 79b are provided, so that ink IK landed on the ink collection sheet 69A by spitting is removed by the cleaning unit 79a and 79b. This prevents ink-dripping from being caused by accumulation of ink landed on the ink collection sheet. An ink collection sheet supply unit 67A includes the ink collection sheet 69A, the sheet winding rollers 75a and 75b, and the cleaning unit 79a and 79b.

Preferably, the ink collection sheet 69A is formed so that the thickness Tf of a downstream edge in a recording medium conveying direction, which extends in a width direction perpendicular to the longitudinal direction of the ink collection sheet, is thinner than the thickness Tb of an upstream edge in the recording medium conveying direction thereof, as shown in FIG. 8B. Thus, the distance between the recording medium S and the ink collection sheet 69A is large at the downstream side in the width direction of the ink collection sheet 69A. Consequently, it is difficult for the ink collection sheet 69A to touch the ink IK landed on the recording medium S.

According to this active energy ray curable inkjet apparatus, normally, as shown in FIG. 7A, the drawing hole 77 is made to coincide with the nozzles. Thus, ink IK discharged from the nozzles can be landed on the recording medium S. Mean while, when the nozzles are cleaned, the sheet winding rollers 75a and 75b are turned to cause the drawing hole to deviate from the nozzles, as shown in FIG. 7B, so that the ink collection sheet 69A is made to coincide with the nozzles and that ink discharged from the nozzles can be landed on the ink collection sheet 69A. Further, when the ink collection sheet 69A is moved out in the opposite direction by the ink collection winding rollers 75a and 75b in an extended condition, as shown in FIG. 7C, the apparatus returns to an original state shown in FIG. 7C, while cleaning the nozzles. With this configuration, the ink collection sheet supply unit 67A can be constituted by a relatively simple structure including only a mechanism adapted to take up the ink collection sheet 69A in which the drawing hole 77 is bored.

Next, a third embodiment of the active energy ray curable inkjet apparatus according to the invention is described below.

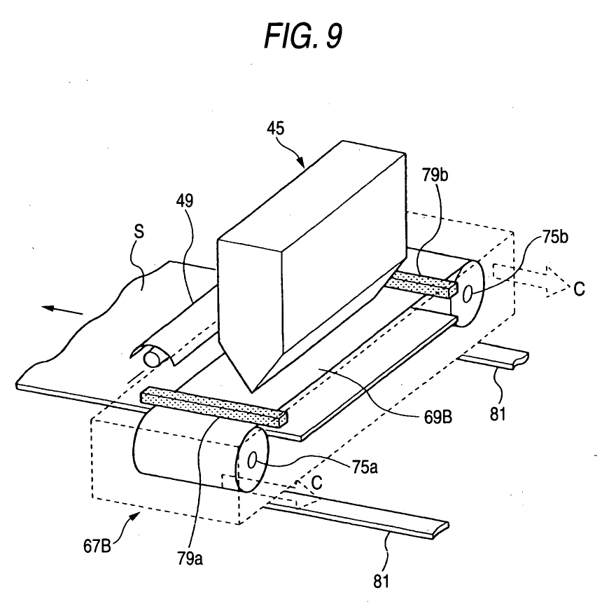

FIG. 9 is an enlarged perspective view illustrating an ink collection sheet supply unit of the active energy ray curable inkjet recording apparatus according to the third embodiment.

This active energy ray curable inkjet apparatus is configured so that a pair of sheet winding rollers 75a and 75b is movable along a recording medium conveying direction by at least a distance by which the ink collection sheet 69B deviates from the nozzles of the head unit 45. That is, the pair of sheet winding rollers 75a and 75b is moved in the direction of an arrow C by guide rails 81 and 81 and an actuator (an electromagnetic plunger (not shown) or an electric motor (not shown)) adapted to cause the sheet winding rollers 75a and 75b to perform a rectilinear motion along the guide rails 81. The ink collection sheet supply unit 67B includes the sheet winding rollers 75a and 75b, the cleaning unit 79a and 79b, the ink collection sheet 69B, the guide rails 81 and the ink collection sheet supply unit 67B.

According to this active energy ray curable inkjet apparatus, normally, the pair of sheet winding rollers 75a and 75b is moved along the recording medium conveying direction, so that the ink collection sheet 69B is disposed to deviate from the nozzles, and that ink IK discharged from the nozzles can be landed on the recording medium S. Also, when the nozzles are cleaned, the pair of sheet winding rollers 75a and 75b is moved and disposed along the recording medium conveying direction, so that ink IK discharged from the nozzles can be landed on the ink collection sheet 69B. With this configuration, when the sheet winding rollers 75a and 75B are moved, so that the ink collection sheet 69B can retreat. This eliminates the necessity for using the ink collection sheet 67A in which the drawing hole 77 is bored.

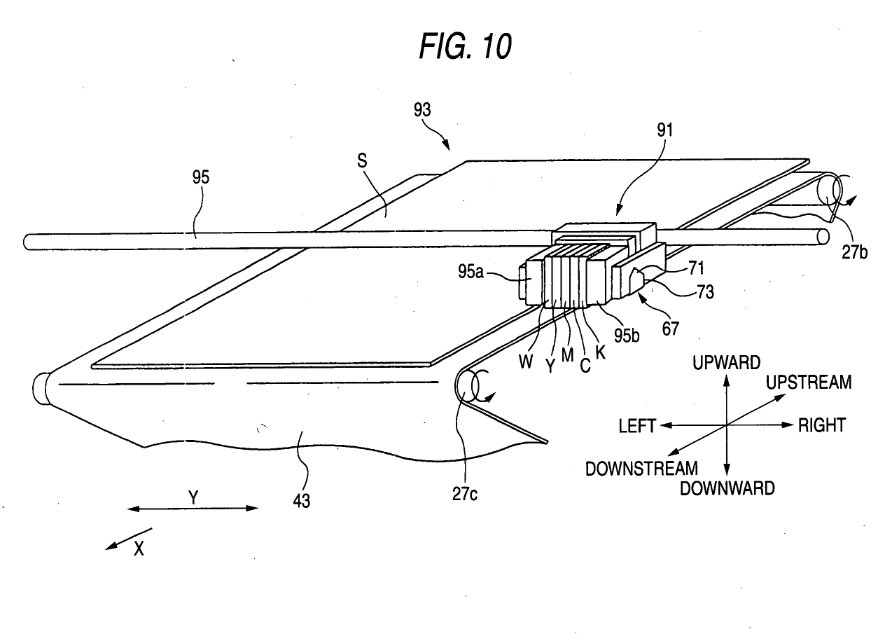

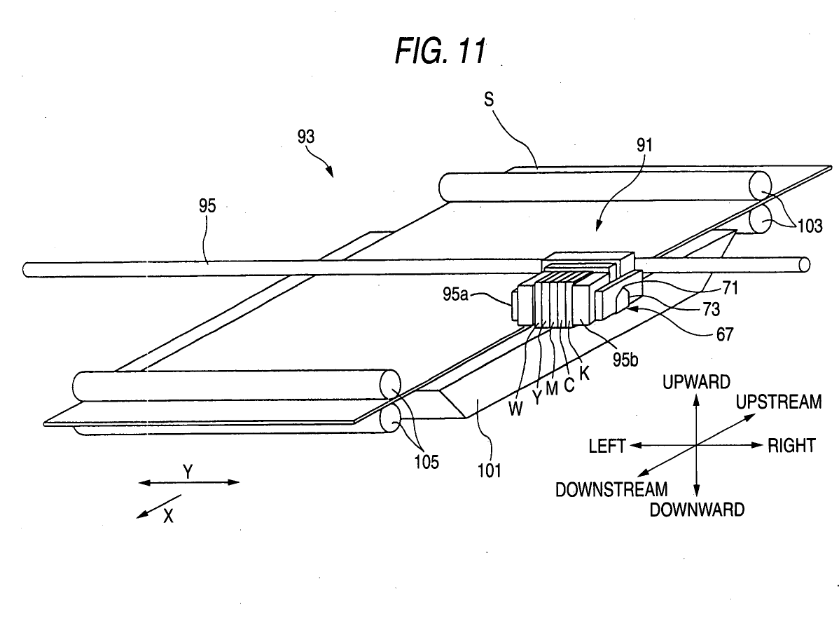

FIG. 10 is a schematic view illustrating another configuration of the active energy ray curable inkjet recording apparatus.

In the active energy ray curable inkjet recording apparatus 100 shown in FIG. 1, the head unit 45 is a line type inkjet head having ink discharging ports arranged in the direction of width of the recording medium S over the entire width thereof. However, a head unit 91 shown in FIG. 10 is of the multi-channel type and performs scanning movement in the direction of width of the recording medium S. The configuration of the active energy ray curable inkjet recording apparatus 100 is described below. Incidentally, in FIG. 10, constituent elements similar in constitution and operation to those shown in FIGS. 1 and 2 are designated by same reference numerals designating such constituent elements in FIGS. 1 and 2.

First, similarly to the apparatus shown in FIG. 1, a conveying belt 43 is stretched and is driven by three belt rollers 27a (not shown in FIG. 10), 27b, and 27c. A tension roller is pushed against the conveying belt 43 that is stretched and is driven by the belt rollers 27a, 27b, and 27c. The conveying belt 43 is driven in a direction from an upstream belt roller 27b to a downstream belt roller 27c. The recording medium S is put on the conveying belt 43 and is conveyed downstream in the conveying direction between the upstream belt roller 27b and the downstream belt roller 27c.

An image recording portion 93 is disposed above the recording medium S to be conveyed between the upstream belt roller 27b and the downstream belt roller 27c. The image recording portion 93 includes a guide member 95, which extends in a direction (scanning direction Y) perpendicular to the conveying direction X, and a head unit 91 to be suspension-supported by the guide member 95. The head unit 91 is set to be reciprocatable along the scanning direction Y. The head unit 91 has 5 nozzle groups each of which is adapted to eject active energy ray curable ink of a corresponding one of 5 colors (white (W), yellow (Y), magenta (M), cyan (C), and black (K)) toward the recording surface of the recording medium S.

Basically, the cartridge mounting portion 31 and the ink supply path vibration portion 59, which are connected to the head unit 91, are similar in constitution to those shown in FIG. 2, respectively. Thus, the description of the cartridge mounting portion 31 and the ink supply path vibration portion 59 shown in FIG. 2 is quoted.

The connection between the head unit 91 and each of the cartridge mounting portion 31 and the ink supply paths 51a, 51b, 51c, 51d, and 51e is described below. The ink supply paths 51a, 51b, 51c, 51d, and 51e extending from the ink supply path vibration portion 59 are made of a flexible tube material. The ink supply paths 51a, 51b, 51c, 51d, and 51e is connected to a connection portion (not shown) disposed just above the head unit 91. Basically, a part extending from the mounting portion 31 to the vibration portion 59 is fixed to the casing 21. Therefore, each of the ink supply paths 51a, 51b, 51c, 51d, and 51e has a flexible configuration to be able to respond to the displacement of the head unit 91.

In the image recording portion 93, ultraviolet irradiating portions 95a and 95b serving as active energy ray precedent-irradiation unit are arranged in the longitudinal direction of the guide member 95 and are disposed on both sides of the head unit 91. The two ultraviolet irradiating portions 95a and 95b serving to perform ultraviolet irradiation are respectively mounted on both the left side and the right side of the head unit 91, as viewed in FIG. 10. The ultraviolet irradiating portions 95a and 95b can be moved together by the reciprocating movement of the head unit 91. The ink IK, which is discharged from the nozzles and is landed on the recording medium S, is irradiated with ultraviolet rays by one of the ultraviolet irradiating portions 95a and 95b, which pass through above the recording medium S just after the ink is landed thereon.

In the head unit 91, an ink collection sheet supply unit 67 is provided so that the bracket 73 can turn around the shaft 71.

Thus, the head unit 91 is provided with the ink collection sheet supply unit 67. Consequently, even in a case where the head unit 91 of this apparatus is of the multichannel type adapted to move in a direction perpendicular to the recording medium conveying direction, the spitting is enabled without moving the head unit 91 to the maintenance portion placed outside the recording area. Further, there is no necessity for providing the spitting maintenance portion outside the recording area. Consequently, images can be formed at a high speed by the apparatus. Additionally, the size of the apparatus can be reduced.

FIG. 11 is a schematic view illustrating still another configuration of the active energy ray curable inkjet recording apparatus.

The active energy ray curable inkjet recording apparatus of this configuration performs image recording by the head unit 91 of the multi-channel type shown in FIG. 10 and a conveyance scanning portion using a fixed platen 101. That is, a plate-like platen 101 supports the recording medium S when an image is recorded. The recording medium S is displaced on the platen 101 by scanning conveyance roller pairs 103 and 105 serving as the displacement unit.

Similarly to the image recording portion shown in FIG. 10, the head unit 91 adapted to record an image on a recording surface of the recording medium S is suspension-supported by the guide member 95 extending in a direction (scanning direction Y) perpendicular to the conveying direction X. The ultraviolet irradiating portions 95a and 95b can be moved together in the Y-direction by the reciprocating motion of the head unit 91. Further, ink IK, which is discharged from each nozzle and is landed on the recording medium S, is irradiated with ultraviolet rays by one of the ultraviolet irradiating portions 95a and 95b, which passes through above the recording medium S just after the ink IK is landed thereon. Subsequently, the scanning conveyance roller pair 105 serving as the displacement unit conveys the recording medium S by sandwiching an end of the recording medium S. Thus, the recording medium S is sent out of the inkjet recording apparatus.

Similar advantages can be obtained by mounting the aforementioned ink collection sheet in the active energy ray curable inkjet recording apparatus of this configuration.

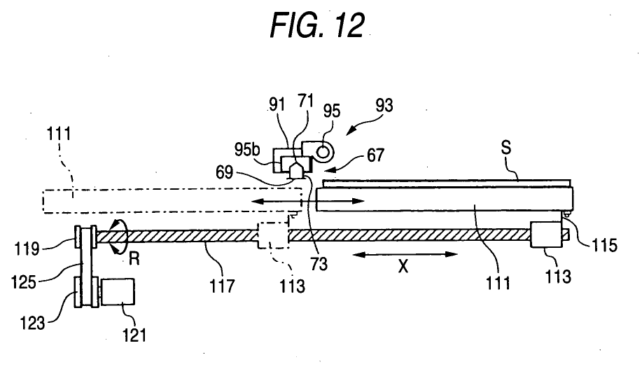

FIG. 12 is a schematic view illustrating a configuration of an active energy ray curable inkjet recording apparatus according to another embodiment of the invention.

As shown in FIG. 12, a mobile platen 111 serving as the displacement unit supports the recording medium S when the recording medium S is conveyed. The mobile platen 111 is shaped like a plate. Preferably, the size of the mobile platen 111 is set at a value slightly larger than the maximum size of the recording medium S there by to support the entire recording medium. A ball nut 113 is fixed to the rear surface opposite to the recording material supporting surface of the mobile platen 111 by a bracket 115. A ball screw shaft 117 penetrating through the ball nut 113 is disposed so that the longitudinal direction of the shaft 117 is parallel to the direction in which the recording medium S is conveyed. The ball nut 113 engages with the ball screw shaft 117 and follows the rotation R of the ball screw shaft 117, so that the movement of the ball nut 113 is regulated to a to-and-fro movement X in the recording medium conveying direction.

A driven timing pulley 119 is disposed at a downstream end in the conveying direction of the ball screw shaft 117. A drive motor 121 is disposed below the mobile platen 111. A timing belt 125 is stretched between a drive timing pulley 123 rotationally driven by the drive motor 121 and the driven timing pulley 119 to thereby transmit a rotation driving force. The drive motor 121 rotates the driven timing pulley 119 to thereby rotate the ball screw shaft 117. Finally, this rotation is converted by the ball nut 113 to a rectilinear movement in the recording medium conveying direction. Then, the mobile platen 111 reciprocates between an initial position, which is indicated by solid lines shown in FIG. 8, and a most downstream position indicated by alternate long and short dash lines.

Also, a plurality of intake holes (not shown) is disposed in a recording medium mounting surface of the mobile platen 111. These intake holes are connected to pipes provided in the platen and are also connected to an intake pipe (not shown) provided in a lower portion of the mobile platen 111. The intake pipe is connected to an intake portion disposed below the mobile platen 111. The recording medium S mounted on the mobile platen 111 is adsorbed by driving this intake portion.

An image recording portion 93 shown in FIG. 11 is disposed in the vicinity of and above a midpoint between the initial position and a downstream position of the mobile platen 111. The image recording portion 93 has the head unit 91 of the multi-channel type. The head unit 91 is suspension-supported by the guide member 95 extending in a scanning direction perpendicular to the to-and-fro movement S in the recording medium conveying direction. The head unit 91 performs reciprocating movement scan along the guide member 95. Basically, the head unit 91 has 5 nozzle groups each of which ejects active energy ray curable ink of a corresponding one of 5 colors (white (W), yellow (Y), magenta (M), cyan (C), and black (K)) toward the recording surface of the recording medium S.

The ultraviolet irradiating portions 95a and 95b are arranged in the longitudinal direction of the guide member 95 and are disposed on both sides of the head unit 91. The ultraviolet irradiating portions 95a and 95b are moved together by the reciprocating movement of the head unit 91. The ink, which is discharged from the nozzles and is landed on the recording medium S, is irradiated with ultraviolet rays.

In the head unit 91, an ink collection sheet supply unit 67 is provided so that the aforementioned bracket 73 can turn around the shaft 71. Thus, an ink collection sheet supply unit similar to the aforementioned one is mounted in the head unit 91. Consequently, similar advantages can be obtained.

Next, an operation of the present embodiment is described below. First, in the case of the present embodiment, the recording medium S is manually supplied to the recording apparatus sheet by sheet when needed. The manually supplied recording medium S is put on the mobile platen 111 that is in the initial position. The mobile platen 111 maintains a halting state until the entire recording medium S is completely put on the mobile platen 111.

Next, an image recording operation of this active energy ray curable inkjet recording apparatus is described below.

First, an image recording operation is started by pushing an image recording start button (not shown) provided in the image recording apparatus. The intake portion (not shown) is driven with this timing at the latest. Thus, the recording medium S mounted on the mobile platen 111 is adsorbed. Also, a driving operation performed by the drive motor 121 to displace the mobile platen 111 is started with this timing.

Incidentally, the torque of the drive motor 121 is transmitted from the drive timing pulley 123 to the driven timing pulley 119 through the timing belt 125 to thereby rotate the ball screw shaft 117. This rotation is converted by the ball nut 113 to a downstream rectilinear movement.

Then, the mobile platen 111 is moved from the initial position to the most down stream position (indicated by alternate long and short dash lines). At that time, the image recording portion 93 starts image recording. That is, the ball nut 113 is moved at a speed for image recording. The head unit 91 performs image recording scan on the recording medium S mounted on the mobile platen 111 moved together with the ball nut 113. Then, upon completion of image recording, the intake portion is stopped at the most downstream position (indicated by alternate long and short dash lines). The recording medium S, on which an image is recorded, is manually collected from the platen 111.

After the recording medium S is removed, the mobile platen 111 placed at the most downstream position (indicated by alternate long and short dash lines) is returned to the initial position by the reverse driving of the drive motor 121. Then, the apparatus waits for the next image recording.

Incidentally, there is no particular limitation on the “active energy ray” described in the present specification. As long as the active energy ray can generate an initiator in the ink composition by irradiating the ray thereonto, any active energy ray may be employed. The “active energy ray” widely includes α rays, γ rays, X rays, ultraviolet rays, visible light rays, and electron beams. Among these kinds of rays, ultraviolet rays and electron beams are preferable, from standpoints of the curing sensitivity of and the availability of a generator of the rays. Especially, ultraviolet rays are more preferable. Accordingly, ink compositions, which are curable by irradiation of ultraviolet rays, are preferable as the ink composition according to the invention.

In the case of the inkjet recording apparatus according to the invention, the peak wavelength of an active energy ray depends on absorption characteristics of a sensitizing dye included in the ink composition and ranges, for example, from 200 nm to 600 nm, preferably, from 300 nm to 450 nm, more preferably, from 350 nm to 450 nm. (a) An electron transferring initiation system included in the ink composition according to the invention has sufficient sensitivity. Thus, the irradiation energy strength of output active energy rays is, for example, 2000 mJ/cm² or less, preferable, ranges from 10 mJ/cm² to 2000 mJ/cm², more preferably, ranges from 20 mJ/cm² to 1000 mJ/cm², further more preferably, 50 mJ/cm² to 800 mJ/cm². The exposure illumination intensity of the active energy rays (the maximum intensity on a surface of the recording medium to be recorded) ranges, for example, from 10 mW/cm² to 2000 mW/cm², preferably, 20 mW/cm² to 1000 mW/cm².

More particularly, in the case of the inkjet recording apparatus according to the invention, preferably, active energy rays are irradiated from a light emitting diode adapted to generate ultraviolet rays adapted so that the emission wavelength peak ranges from 390 nm to 420 nm, and that the maximum intensity on the surface of the recording medium ranges from 10 mW/cm² to 1000 mW/cm².

Also, in the case of the inkjet recording apparatus according to the invention, the active energy rays are irradiated onto the recording medium, for example, 0.01 seconds to 120 seconds, preferably, 0.1 seconds to 90 seconds.

Additionally, in the case of the inkjet recording apparatus according to the invention, preferably, the ink composition is heated to a predetermined temperature. Also, a desirable time from a moment, at which the ink composition is landed on the recording medium, to a moment at which the active energy rays are irradiated thereonto, ranges from 0.01 seconds to 0.5 seconds, preferably, from 0.01 seconds to 0.3 seconds, more preferably, from 0.01 seconds to 0.15 seconds. Thus, the time from a moment, at which the ink composition is landed on the recording medium, to a moment at which the active energy rays are irradiated thereonto, is controlled to be an extremely short time. Consequently, the ink composition landed thereon can be prevented from blurring before cured.

Incidentally, to obtain a color image using the inkjet recording apparatus according to the invention, it is preferable to perform the overglaze of colors applied sequentially from a low-luminosity color to a high-luminosity color. Thus, active energy rays can easily reach a lower ink layer. Consequently, good curing sensitivity, reduction of residual monomers, odor reduction, and enhancement of adhesiveness can be achieved. Although a recording medium can be simultaneously irradiated with and exposed to active energy rays of all colors, it is preferable from a standpoint of promoting curing to expose the recording medium to rays, color by color.

Also, as described above, in a case of the ink composition according to the invention, which is active energy ray curable ink, it is desirable to maintain a discharged ink composition at a constant temperature. Thus, preferably, the temperature of a part extending from an ink supply tank to an inkjet head portion is controlled adiabatically or by heating. Also, preferably, the head unit to be heated is thermally insulated or is heat-rejected so as to prevent the body of the apparatus from being affected by the temperature of ambient air. Additionally, to reduce a printer start-up time required to heat the head unit, or to reduce the loss of heat energy, preferably, the head unit is thermally insulated from other parts. Also, preferably, the heat capacity of the entire heating unit is reduced.

A mercury lamp, a gas laser, and a solid-state laser may be used as an active energy ray source. In the case of an ultraviolet curable inkjet apparatus, a mercury lamp and a metal halide lamp are widely known sources of ultraviolet rays. It is very useful from an industrial standpoint and an environmental standpoint to replace such a source with a GaN semiconductor ultraviolet emitting device. Additionally, an LED (UV-LED) and an LD (UV-LD) are small in size, long in life, high in efficiency, and low in cost. Therefore, the LED (UV-LED) and the LD (UV-LD) are expected to be an effective radiation source for an active energy ray curable inkjet apparatus.

As described above, the light emitting diode (LED) and the laser diode (LD) can be used as the source of active energy rays. Especially, in a case where a source of ultraviolet rays is employed, an ultraviolet LED and an ultraviolet LD can be used. For example, Nichia Corporation places an ultraviolet LED, whose main emission spectrum has wavelengths ranging from 365 nm to 420 nm, on the market. The description of the U.S. Pat. No. 6,084,250 discloses an LED enabled to radiate active energy rays, whose wavelengths centered on a range from 300 nm to 370 nm, to be suitable for a case where rays of shorter wavelengths are necessary. Also, other ultraviolet LEDs enabled to irradiate ultraviolet rays of different bands are available. A preferable source of active energy rays for apparatuses according to the invention is a UV-LED. A more preferable source of active energy rays is a UV-LED whose peak wavelength ranges from 350 nm to 420 nm.

Recording Medium to Be Recorded

There is no particular limitation on the recording medium to which an ink composition according to the invention can be applied. Ordinary paper and the like, such as non-coated paper and coated paper, various non-absorbable resin materials used for what is called flexible packaging, or resin films produced by forming the non-absorbable resin material into a film-like medium can be used as the recording medium. Various plastic films, which can be used as the recording medium, are, for example, PET films, OPS films, OPP films, ONy films, PVC films, PE films, and TAC films. Additionally, plastic materials, which can be used as the material of the recording medium to be recorded, are, for instance, polycarbonate, acrylic resins, ABS, polyacetal resins, PVA, rubber and the like. Also, metals, glasses, and the like can be used as the recording medium to be recorded.

In a case where materials, whose heat shrinkage at curing is small, are selected as the material of the ink composition according to the invention, the adhesiveness between the cured ink composition and the recording medium to be recorded is high. Thus, the invention has an advantage in that even in a case where films, which are easily curled or deformed due to the curing/shrinkage of ink and to heat generated by a curing reaction, for example, heat-shrinkable PET films, OPS films, ONy films, and PVC films are employed, high-resolution images can be formed.

The active energy ray curable inkjet apparatus according to the invention has the ink collection sheet supply unit adapted to perform face-to-face supply of a spitting ink collection sheet to nozzles of the inkjet head. Thus, even in a case where the inkjet apparatus has a full line head in which the head is always present above the recording area, the face-to-face supply of the ink collection sheet to the nozzles can be achieved. Also, the spitting can easily be performed. The clogging of the nozzles can be suppressed. Also, in a case where the head of the inkjet apparatus is of the multichannel type adapted to move in a direction perpendicular to the recording medium conveying direction, the spitting can be performed without moving the head to the maintenance portion placed outside the recording area. Further, there is no necessity for providing the spitting maintenance portion outside the recording area. Consequently, the image quality of an image formed by the apparatus can be enhanced. Images can be formed at a high speed by the apparatus. Additionally, the size of the apparatus can be reduced.

The entire disclosure of each and every foreign patent application from which the benefit of foreign priority has been claimed in the present application is incorporated herein by reference, as if fully set forth.

What is claimed is:

1. An active energy ray curable inkjet apparatus comprising:
an inkjet head adapted to discharge ink, which is curable by active energy rays, to a recording medium; and
a displacement unit adapted to cause the recording medium and the inkjet head to perform relative displacement,
wherein the active energy ray curable inkjet apparatus further comprises:
an ink collection sheet supply unit adapted to perform face-to-face supply of a spitting ink collection sheet to nozzles of the inkjet head.

2. The active energy ray curable inkjet apparatus according to claim 1,
wherein the ink collection sheet supply unit is provided at the inkjet head.

3. The active energy ray curable inkjet apparatus according to claim 1, which further comprises:
a band-like ink collection sheet intervened between the recording medium and the inkjet head; and
a pair of sheet winding rollers adapted to take up and draw out both ends in a longitudinal direction of the band-like ink collection sheet,
wherein a drawing hole, through which nozzles juxtaposed in the inkjet head are exposed, is formed in the band-like ink collection sheet.

4. The active energy ray curable inkjet apparatus according to claim 1, which further comprises:
a band-like ink collection sheet intervened between the recording medium and the inkjet head; and
a pair of sheet winding rollers adapted to take up and draw out both ends in a longitudinal direction of the band-like ink collection sheet,
wherein the pair of sheet winding rollers is movable along a recording medium conveying direction by at least a distance by which the ink collection sheet deviates from the nozzles of the inkjet head.

5. The active energy ray curable inkjet apparatus according to claim 3, which further comprises:
a cleaning unit adapted to clean ink landed onto the band-like ink collection sheet.

6. The active energy ray curable inkjet apparatus according to claim 3,
wherein a thickness of a downstream edge in a recording medium conveying direction, which extends in a width direction perpendicular to a longitudinal direction of the band-like ink collection sheet, is thinner than a thickness of an upstream edge in the recording medium conveying direction of the band-like ink collection sheet.
